(19) United States
(12) Patent Application Publication
(10) Pub. No.: US 2007/0068445 A1
(43) Pub. Date: Mar. 29, 2007

(54) Non-furling flag

(76) Inventor: Jack C. Priegel, El Paso, TX (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/237,265

(22) Filed: Sep. 28, 2005

(51) Int. Cl. G09F 17/00

(52) U.S. Cl. 116/174

(57) ABSTRACT

A flag having non-furling properties. The flag generally includes a planar surface and a non-furling portion, which cooperate with a mounting cap to generally provide non-furling features to the flag. The non-furling portion may include a sleeve portion on a side of the flag surface and a flap portion extending outwardly from the sleeve portion. The sleeve portion generally defines an internal cavity through which a flag pole may be inserted. The flap portion may be folded over an opening to the sleeve portion and be rotatably secured the mounting cap, which is mounted on an end of the flagpole. The sleeve portion rotates about the received flag pole such that the furling of the flag is substantially prevented.

### FIELD OF THE INVENTION

The invention is to a flag and, in particular, to a flag having non-furling properties.

### BACKGROUND OF THE INVENTION

Flags are best viewed when extended and waving in the breeze. However, upon sudden changes in wind direction or velocity, a flag may wrap around the flag pole from which it is suspended. Upon further wind velocity and directional changes, the flag may completely wrap around the pole. In this condition, a furled or wrapped flag presents an unsightly appearance. To unfurl such flags, it is often necessary to remove the flag from the pole.

Attempts have been made to suspend a flag from a pole to prevent furling. For instance, a pair of spaced swivel assemblies that are mounted to the flag pole have been used to secure the top and bottom edges of the flag through inter-connecting ring members. Such swivel assemblies allow the flag to spin around the pole because the swivel rotates relative to the pole. However, the swivel connection is complicated. It requires a pair of swivel assemblies, each of which include ball bearings, that need to be mounted to the flag pole by drilling holes in the pole and using set screws. Other attempts to prevent flag furling use an inverted L-shaped bracket, which has one leg of the L-shape inserted into a sleeve upon a top edge of the flag and the other leg of the L-shape inserted into a bore of a flag pole. The leg in the bore allows the flag to rotate around the pole. However, the leg in the upper flag sleeve holds the flag in an unnatural position so that the flag does not naturally wave in the breeze. U.S. Pat. Nos. 5,375,555; 5,267,524; and 4,123,813 are examples of such prior systems to secure a flag to a pole and prevent furling.

As a result, it is desired to obtain a simple, non-furling flag that allows a flag to naturally wave in the breeze with a minimum number of modifications to the flag pole.

### SUMMARY OF THE INVENTION

The invention provides a flag having non-furling properties. In one form, the flag includes a planar flag surface that has a sleeve portion on at least one side of the flag surface. The sleeve portion generally defines an internal cavity having openings on ends thereof that may receive a flag pole therein. Extending outwardly from at least one end of the sleeve portion is a flap portion that is foldable over one of the sleeve portion openings. Preferably, a folded flap portion rotatably secures the flag to an end of a received flag pole so that the sleeve portion is rotatable about the flag pole so that the furling of the planar flag surface is substantially prevented.

In another form, the invention provides a flag assembly having non-furling properties. The flag assembly may include a flagpole having a bore therethrough, a flag, a securing cap received in the bore for joining the flag to the flagpole. Similar to above, the flag may include a planar flag surface and a sleeve formed on a side of the flag surface having opposed openings at ends thereof to receive the flagpole therein. The sleeve may have a flap extending outwardly from one of the sleeve ends. The flap is generally foldable over one of the sleeve openings to rotatably secure the flap to the flag pole. Preferably, the flap includes an aperture for receiving a portion of the securing cap. That is, for example, the securing cap may have a pivot extending therefrom, which is inserted in the aperture of a folded flap to secure the flag to the received flag pole. In such arrangement, the sleeve is rotatable about the flag pole so that furling of the flag planar surface is substantially prevented.

### BRIEF DESCRIPTION OF THE DRAWINGS

FIG. 1 is an exploded view of an exemplary flag assembly embodying features of the present invention;

FIG. 1A is a perspective view of an exemplary flag from the flag assembly of FIG. 1;

FIG. 2 is a perspective view of an exemplary mounting cap from the flag assembly of FIG. 1;

FIG. 3 is a exploded view of the mounting cap and exemplary flagpole of FIG. 1

FIG. 4 is a perspective view of the mounting cap and flagpole of FIG. 3 with a portion of the flagpole cut away;

FIG. 5 is a perspective view of the flag assembly of FIG. 1 shown in an exemplary, partially assembled arrangement;

FIG. 6 is a perspective view of the flag assembly of FIG. 5 shown in an exemplary assembled arrangement; and

FIG. 7 is a partial cross-sectional view generally taken along the lines 7-7 in FIG. 6 of an exemplary assembled flag assembly.

### DESCRIPTION OF THE PREFERRED EMBODIMENTS

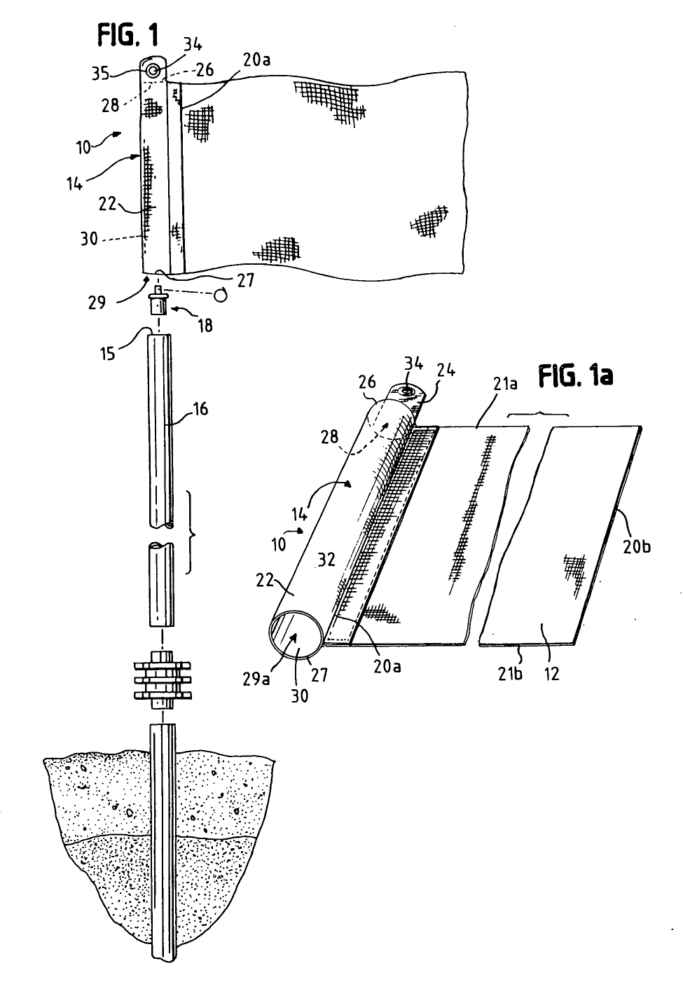

Referring to FIG. 1, an exemplary flag 10 is illustrated having non-furling features. In this embodiment, the flag 10 includes a typical planar flag surface 12 combined with a non-furling portion 14. To mount the flag 10 to an exemplary tubular flag pole 16, a mounting or securing cap 18 may be used that cooperates with the non-furling portion 14 to prevent the flag 10 from wrapping around the pole 16. The flag pole 16 may be a variety of lengths or, as illustrated in FIG. 1, may be multiple sections joined by a coupling member. In addition, the flag pole 16 may be secured in the ground, as illustrated, or secured to a variety of structures, such as buildings, sheds, fences, or the like. For purposes of this invention, the terms non-wrapping, non-furling, or non-fouling mean flag surface 12 not curling around the flag pole 14, and such phrases may be used interchangeably.

More specifically, as shown in FIGS. 1 and 1A, the flag surface 12 may be any planar surface having a variety of shapes. The flag surface 12 is the portion of the flag 10 that waves in the breeze like a typical flag. The surface 12 may includes a single panel, as illustrated, or a plurality of separate panels that independent wave in the breeze. The flag surface 12 may be constructed out of common flag materials, such as polyester, kitten polyester, woven polyester, nylon, cotton, or other suitable flag fabrics. In one form, the flag surface 12 is a generally rectangular planar surface that has spaced vertical end edges 20a and 20b and spaced horizontal side edges 21a and 21b.

Along the vertical end edge 20a of the flag planar surface 12 extends the non-furling portion 14, which includes a sleeve portion 22 and a flap portion 24. The sleeve portion 22, the flap portion 24, and the mounting cap 18 cooperate to provide non-furling features to the flag 10.

The sleeve portion 22 is a hollow, tubular structure that extends at least a portion of the length of the vertical end edge 20a, and preferably, extends the entire length of the vertical end edge 20a. The sleeve portion 22 is formed from a generally annular wall 32 that defines an internal cavity 30. At opposite ends of the annular wall 32 are upper and lower end edges 26 and 27, respectively, which define upper and lower openings 28 and 29, respectively, into the cavity 30. Preferably, the annular wall 32 is formed from the same flag material used to form the planar flag surface 12; therefore, the sleeve portion 22 is preferably also a fabric material as previously described.

In one embodiment, the sleeve portion 22 is formed by looping a free edge of the flag surface 12 back around to the planar surface 12 to form the annular wall 32. The tubular, sleeve portion 22 is then formed by stitching the free edge to the planar flag surface 12 vertically along end edge 20a as generally illustrated in FIG. 1a. Preferably, the diameter of the generally tubular sleeve 22 is sized to slideably receive the flagpole 16. That is, the sleeve 22 has a diameter that is slightly larger than the diameter of the flagpole 16 to allow sufficient rotation of the sleeve 22 thereabout. Most preferably, for a one inch diameter flagpole 16, the sleeve 22 generally has a diameter of about one-and-a-half inches; however, other diameter flagpoles will require different diameter sleeves 22.

The non-furling portion 14 also includes the flap portion 24, which extends outwardly from the upper sleeve portion edge 26. In one form, the flap portion 24 is a generally semi-circular flap that is sized about the same as the opening 28 and, preferably, is also fabricated from the same flag material used to form the sleeve 22 and the flag surface 12 as previously described. The flap portion 24 includes an aperture 34 that is preferably centrally located within the flap. To ensure durability to the aperture 34, it may be defined by a grommet, bushing, or other protective structure 35. The flap portion 24 is foldable at a fold portion 25 (FIGS. 6 and 7) over the upper opening 28 and, as will be further described below, secures the flag 10 to a top edge 15 of the flagpole 16 in such a manner that the sleeve 22 is rotatable about the flagpole 16.

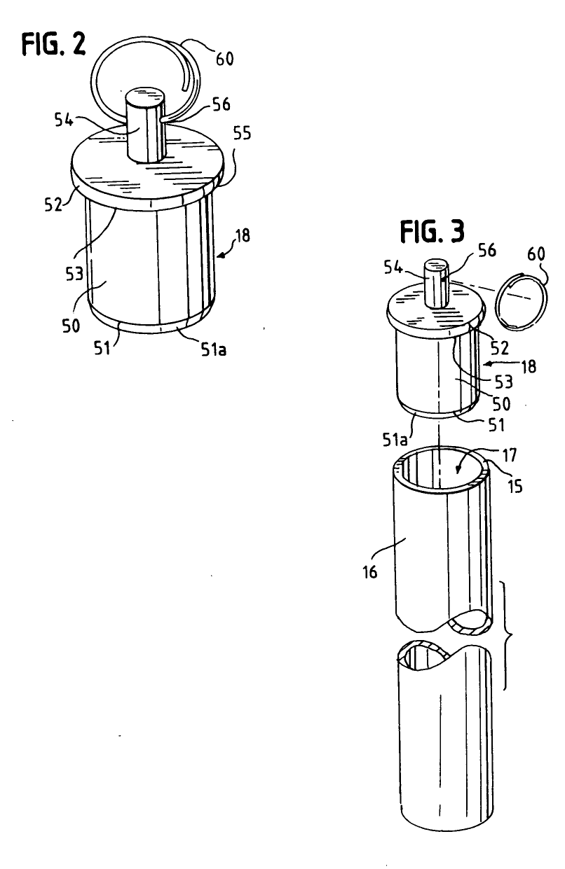

Referring to FIGS. 2-4, the mounting cap 18 is illustrated in more detail. The mounting cap 18 is generally a cylindrical plug that is receivable in an internal bore 17 of the tubular flagpole 16, such as a hollow tubular conduit, at the top edge 15 thereof. Preferably, the mounting cap 18 is constructed out of ABS, nylon, or other suitable plastics. In the embodiment shown, the mounting cap 18 includes a tapered body portion 50 that has an outwardly extending flange 52 at a top end thereof.

The body portion 50 is generally an inwardly tapered, cylindrical structure that is sized to be inserted into the hollow bore 17 of the tubular flagpole 16 at the top edge 15. It is preferred that the mounting cap 18 be received in the flagpole bore with a tight, friction fit. Therefore, the body portion 50 has a diameter at a top end 53 that is about the same as the inside diameter of the flagpole bore 17 and then tapers inwardly down to a bottom end 51 that has a diameter of slightly less than the inside diameter of the flagpole bore 17. The tapered configuration allows the body portion 50 is be easily inserted into the flagpole bore 17 at the bottom end 51, where the diameter is less than the inside of the flagpole 16, and then urged to a tight, friction fit at the top end 53, where the diameter is about equal to the inside of the flagpole. To facilitate the initial insertion of the bottom end 51 into the bore 17, the body portion 50 may also include a chamfered portion 51a at the bottom end 51. The chamfered portion 51a circumscribes the bottom end 51 and also tapers inwardly to the body 50 so that the body portion 50 may easily slide into the bore 17.

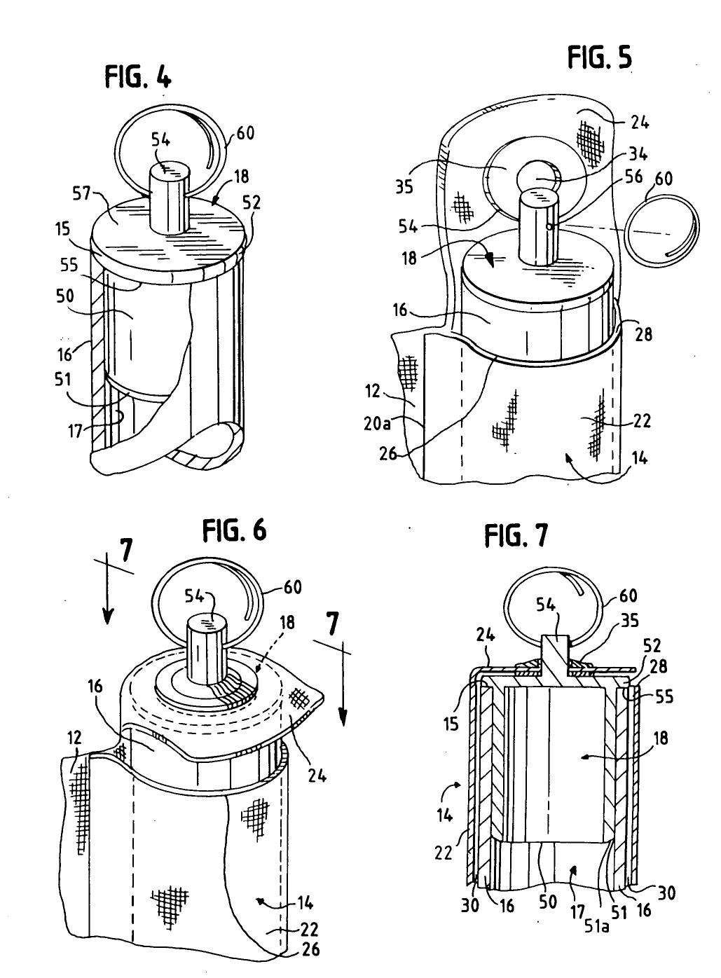

The outwardly extending flange 52 is at the top end 53 of the body portion 50. In one form, the flange 52 is an enlarged disk having a diameter generally larger than the body portion top end 53. The flange 52 is for stopping the mounting cap 18 from being inserted all the way into the flagpole hollow bore 17. In that regard, the flange 52 includes a stop surface 55 on the underside of the flange 52 that engages the top edge 15 of the flagpole 16 to define a predetermined position of the mounting cap 18 in the flagpole 16 as illustrated in FIGS. 4 and 7.

Protruding outwardly from a top surface 57 of the mounting cap 18 is a pivot 54. Preferably, the pivot 54 is a cylindrical extension having a diameter less than the diameter of the body portion 50 and is approximately centrally disposed on the top surface 57. The pivot 54 may also include an aperture 56 therethrough to receive a securing member 60 therein. The securing member 60 may be a cotter pin, coiled wire, screw, or the like. The pivot 54 is sized to be rotatably insertable into the flap aperture 34. That is, the pivot 54 and the flap aperture 34 preferably have a loose, rotational fitting engagement. The aperture 34, for instance, is generally slightly larger than the outside diameter of the pivot 54 to allow rotation of the flap 24 thereabout.

Referring to FIGS. 5-7, a detailed view of the cooperation of the non-furling portion 14 of the flag 10, the flagpole 16, and the mounting cap 18 is shown. The body portion 50 of the mounting cap 18 is first inserted into the flag pole hollow cavity 17 at the top end 15 thereof and urged therein until the flange stop surface 55 engages the top end 15 of the flagpole 16. The sleeve 22 is then inserted over the flagpole 16 so that the pole 16 is inserted into the sleeve cavity 30. The sleeve 22 is then slid downwardly over the flagpole 16 until the mounting cap 18 at the top end of the pole 16 is protruding outwardly from the sleeve upper opening 28 as illustrated in FIG. 5. The flap 24 is then folded at the fold portion 25 over the mounting cap 18 and the pivot 54 is inserted through the flap aperture 34 as shown in FIG. 6. Preferably, the flap 24 is folded until it is below the pivot aperture 56. When folded to this position, the aperture 56 of the pivot 54 is generally above the flap 24; therefore, the securing member 60 may be inserted through the pivot aperture 56 and also secure the flag 10 to the flagpole 16. That is, the securing member 60 holds the flap 24 in its folded position adjacent the flagpole top end 15 and, therefore, prevents the flag 10 from sliding down the length of the flagpole 16 as shown in FIGS. 6 and 7.

In such preferred configuration, the mounting cap 18 and the non-furling portion 14 of the flag 10 cooperate to impart non-furling features thereto. That is, as the wind changes direction or velocity, which may cause the flag planar surface 12 to shift from a first flag waving direction to a second flag waving direction, the sleeve portion 22 also rotates around the flagpole in the same direction. For example, as described above, the pivot 54 protrudes through the flap aperture 34, which allows the flap 24 to rotate about the flagpole 16. Therefore, as the flap 24 is rotatable around the flag pole 16, so is the sleeve 22 because of its larger diameter relative thereto and its foldable connection to the flap 24 via the fold portion 25. As a result, as the flag planar surface 12 shifts to a different direction, the sleeve 22 is able to rotate in a similar rotational direction. In this manner, the rotation of the sleeve 22 in the same direction as the flag planar surface 12 allows the planar surface 12 to re-orient in the new flag waving direction before the planar surface 12 curls around the flagpole 16. Consequently, each time the flag surface 12 attempts to shift to a new flag waving direction from wind changes, the mounting cap 18 and flag non-furling portion 14 cooperate in a similar fashion to re-orient the flag planar surface 12 so that the flag does not furl around the flagpole 16.

It will be understood that various changes in the details, materials, and arrangements of parts and components, which have been herein described and illustrated in order to explain the nature of the invention may be made by those skilled in the art within the principle and scope of the invention as expressed in the appended claims.

What is claimed is:

1. A non-furling flag comprising:
a planar flag surface;
a sleeve portion on a side of the flag surface, the sleeve portion defining an internal cavity and having opposed openings at ends thereof, a flag pole being receiveable therein;
a flap extending outwardly from an end of the sleeve portion, the flap being foldable over one of the sleeve portion openings, wherein a folded flap rotatably secures the flag to an end of a received flag pole; and
the sleeve portion being rotatable about a received flag pole such that the furling of the planar flag surface is substantially prevented.

2. The non-furling flag of claim 1, further comprising an aperture in the flap; a mounting cap receivable in a distal end of a received flag pole; and a pivot extending from a top surface of the mounting cap, the pivot being insertable through the aperture of a folded flap such that the flap is rotatable about the pivot.

3. The non-furling flag of claim 2, wherein the mounting cap comprises a body portion receivable in a bore of a flag pole; an outwardly extending flange portion at an end of the body portion; and a stop surface on the flange portion to hold the mounting cap at a top end of a flag pole.

4. The non-furling flag of claim 3, wherein the pivot is a cylindrical pin extending outwardly from the top surface of the mounting cap.

5. The non-furling flag of claim 4, wherein the cylindrical pin further comprises an aperture therethrough; and a securing member sized for insertion through the aperture to rotatably secure a folded flap to the mounting cap.

6. The non-furling flag assembly of claim 1, further comprising a stitching extending along an edge of the planar surface forming the sleeve therefrom.

7. A non-furling flag assembly comprising:
a flagpole having a bore therethrough;
a flag comprising
a planar flag surface;
a sleeve formed on a side of the flag surface, the sleeve having opposed openings at ends thereof to receive the flagpole therein;
a flap extending outwardly from an end of the sleeve, the flap being foldable over one of the sleeve openings; and
an aperture disposed on the flap;
a securing cap having a pivot extending therefrom, the securing cap received in the flagpole bore; and
the pivot inserted in the aperture of a folded flap to secure the flag to the received flag pole such that the sleeve is rotatable thereabout so that furling of the flag planar surface is substantially prevented.

8. The non-furling flag assembly of claim 7, further comprising a stitching extending along an edge of the planar surface forming the sleeve therefrom.

9. The non-furling flag assembly of claim 7, wherein the securing cap further comprises a tapered body portion inserted in the bore of the flag pole and an outwardly extending flange portion having a stop surface thereon interfering with a distal end of the flag pole for holding the securing cap to the distal end of the flag pole.
